(19) United States
(12) Patent Application Publication
(10) Pub. No.: US 2020/0187317 A1
(43) Pub. Date: Jun. 11, 2020

(54) MICROWAVE APPLICATOR

(71) Applicant: NATIONAL TSING HUA UNIVERSITY, Hsinchu (TW)

(72) Inventors: Tsun-Hsu CHANG, Hsinchu City (TW); Hsien-Wen CHAO, Taoyuan City (TW); Shen-Fu CHEN, Changhua County (TW)

(21) Appl. No.: 16/541,186

(22) Filed: Aug. 15, 2019

(30) Foreign Application Priority Data
Dec. 6, 2018 (TW) 107143975

(51) Int. Cl. H05B 6/78; H05B 6/80

(52) U.S. Cl. CPC H05B 6/78; H05B 6/806; H05B 6/802

(57) ABSTRACT

A microwave applicator includes a chamber, at least one microwave source, a stirrer and a cooling structure. The microwave source is disposed on one side of the chamber. The stirrer is disposed in the chamber, wherein the stirrer includes an axial member and a plurality of blades. Each of the blades is connected to the axial member, and the axial member and the blades are made of metal materials. The cooling structure is disposed in the chamber and includes at least one cooling tube for allowing a cooling liquid passing through the chamber.

### RELATED APPLICATIONS

This application claims priority to Taiwan Application Serial Number 107143975, filed Dec. 6, 2018, which is herein incorporated by reference.

### BACKGROUND

### Technical Field

The present disclosure relates to a microwave applicator. More particularly, the present disclosure relates to a microwave applicator for heating through microwaves to promote a chemical reaction.

### Description of Related Art

Microwaves can pass through materials and cause polar molecules to start oscillating so as to heat them up uniformly. Many studies also prove that the microwaves can raise a reaction rate of a chemical reaction so that the microwaves have been broadly applied in various industries recently.

Due to characteristics of the microwaves and a directivity waveguide, a stirring bar is necessary during an object is heated. Furthermore, the stirring bar is usually made of a non-metal material so that a point discharge can be avoided in the above heating process. However, for the object with a higher viscosity, the non-metal stirring bar cannot stir successfully and is even damaged easily.

### SUMMARY

According to one aspect of the present disclosure, a microwave applicator includes a chamber, at least one microwave source, a stirrer and a cooling structure. The microwave source is disposed on one side of the chamber. The stirrer is disposed in the chamber and includes an axial member and a plurality of blades. Each of the blades is connected to the axial member, and the blades and the axial member are made of metal materials. The cooling structure is disposed in the chamber and includes at least one cooling tube for allowing a cooling liquid passing through the chamber.

According to another aspect of the present disclosure, a microwave applicator includes a chamber, at least one microwave source and a stirrer. The chamber includes an inner chamber wall and an outer chamber wall. The outer chamber wall surrounds the inner chamber wall and includes a cooling chamber for introducing a cooling liquid thereinto. The microwave source is disposed on the outer chamber wall of the chamber. The stirrer is disposed in the chamber and includes an axial member and a plurality of blades. Each of the blades is connected to the axial member, and the axial member and the blades are made of metal materials.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a microwave applicator according to one embodiment of the present disclosure.

FIG. 2 is a three dimensional view of an axial member and blades of FIG. 1.

FIG. 3 is a top view of the axial member and the blades of FIG. 1.

FIG. 4 is a side view of the blades of FIG. 1.

FIG. 5 is a schematic view of cooling tubes of FIG. 1.

FIG. 6 is a schematic view of cooling tubes according to another embodiment of the present disclosure.

FIG. 7 is a partial cross-sectional view of the microwave applicator of FIG. 1.

FIG. 8 is a schematic view of an axial member and blades of a microwave applicator according to another embodiment of the present disclosure.

FIG. 9 is a schematic view of a microwave applicator according to yet another embodiment of the present disclosure.

### DETAILED DESCRIPTION

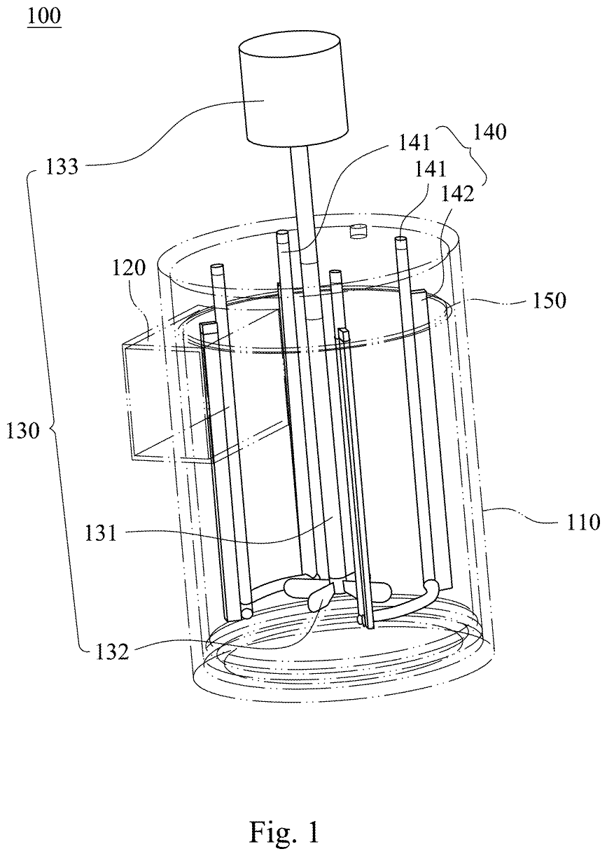

FIG. 1 is a schematic view of a microwave applicator 100 according to one embodiment of the present disclosure. In FIG. 1, the microwave applicator 100 includes a chamber 110, at least one microwave source 120, a stirrer 130 and a cooling structure 140. The microwave source 120 is disposed on one side of the chamber 110. The stirrer 130 and the cooling structure 140 are disposed in the chamber 110. The microwave source 120 is provided for evenly heating an object in the chamber 110 so as to raise a reaction rate of a chemical reaction of the object in the chamber 110. When the object is overheated by the microwave source 120 without boiling, it will boil immediately and splash out as the chamber 110 is shaken by an external force. To solve the above-mentioned issue, the microwave applicator 100 of the present disclosure provides the stirrer 130 and the cooling structure 140 disposed in the chamber 110 for stabilizing the heating process.

In details, the stirrer 130 includes an axial member 131 and a plurality of blades 132. Each of the blades 132 is connected to the axial member 131, and the blades 132 and the axial member 131 are made of metal materials. The axial member 131 can be forced to rotate for driving the blades 132 to stir the object in the chamber 110. The arrangement of the metal components, that is, the blades 132 and the axial member 131, can enhance the strength of the stirrer 130 for stirring the sticky object. Furthermore, the blades 132 and the axial member 131, which are made of the metal materials, can achieve a converging electric field for allowing the microwaves focusing on the object so as to improve the efficiency of speeding up the chemical reaction rate by the microwaves.

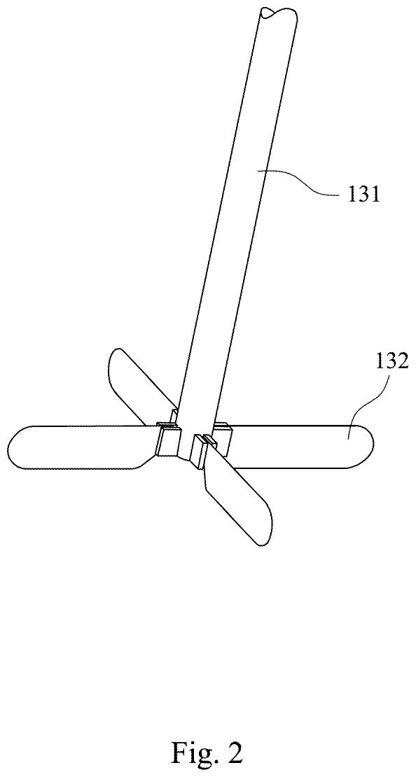

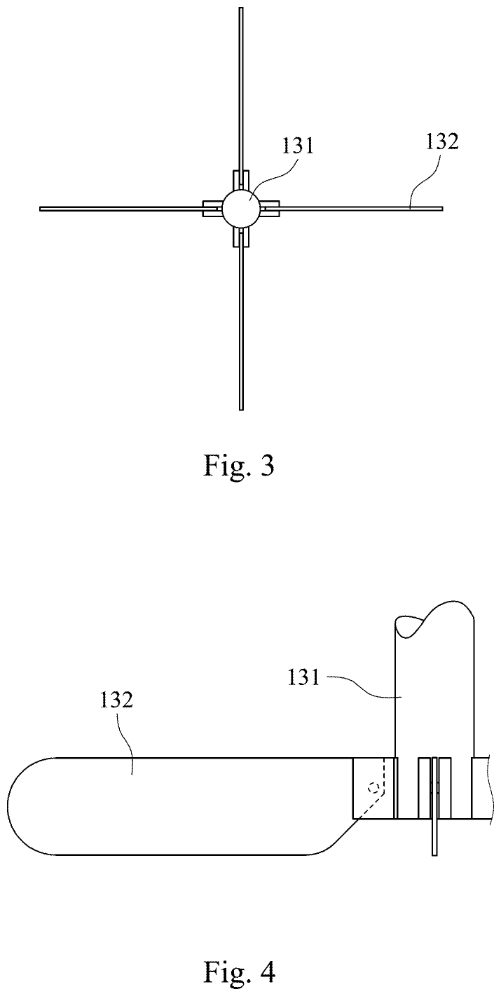

FIG. 2 is a three dimensional view of the axial member 131 and the blades 132 of FIG. 1, FIG. 3 is a top view of the axial member 131 and the blades 132 of FIG. 1, and FIG. 4 is a side view of the blades 132 of FIG. 1. In FIG. 2, FIG. 3 and FIG. 4, a number of the blades 132 of the stirrer 130 can be four. An angle between each two of the blades 132 which are adjacent to each other can be 90 degrees, and the angles between every two of the blades 132 which are adjacent to each other are equal. In consideration of the position of the microwave source 120 corresponding to the stirrer 130, as the microwave source 120 is a WR340 waveguide, the microwaves are introduced into the chamber 110 from one side thereof. According to the arrangement of the blades 132 in FIG. 2 and FIG. 3, a shadow area on the blades 132, which is projected by the microwaves, will not affected by the rotation of the blades 132 during stirring. Thus, the effect of evenly heating for the object in the chamber 110 can be maintained. Moreover, the number of the blades 132 can be five, six or more, and the angles between every two of the blades 132 which are adjacent to each other are equal. For example, the angle between each two of the blades 132 which are adjacent to each other can be 72 degrees when the number of the blades 132 is five. Alternatively, the angle between each two of the blades 132 which are adjacent to each other can be 60 degrees when the number of the blades 132 is six. Although additional drawings and descriptions are not provided herein, the number and arrangement of the blades of the present disclosure will not limited to any of the abovementioned examples.

In FIG. 4, an edge of each of the blades 132 can be arc-shaped. Although the blades 132 of the stirrer 130 are made of the metal materials to enhance its strength for stirring various kinds of objects, the point discharge occurs during the heating process of the microwaves if the side edge of the blade 132 is sharp or has a smaller radius of curvature so as to affect the quality of the object to be heated. Thus, the edge of each blade 132 can be arc-shaped for avoiding the occurrence of the point discharge.

In order to allow the stirrer 130 smoothly driving the axial member 131 to rotate the blades 132, the stirrer 130 can further include a motor 133. The motor 133 is connected with the axial member 131 for driving the axial member 131 to rotate the blades 132.

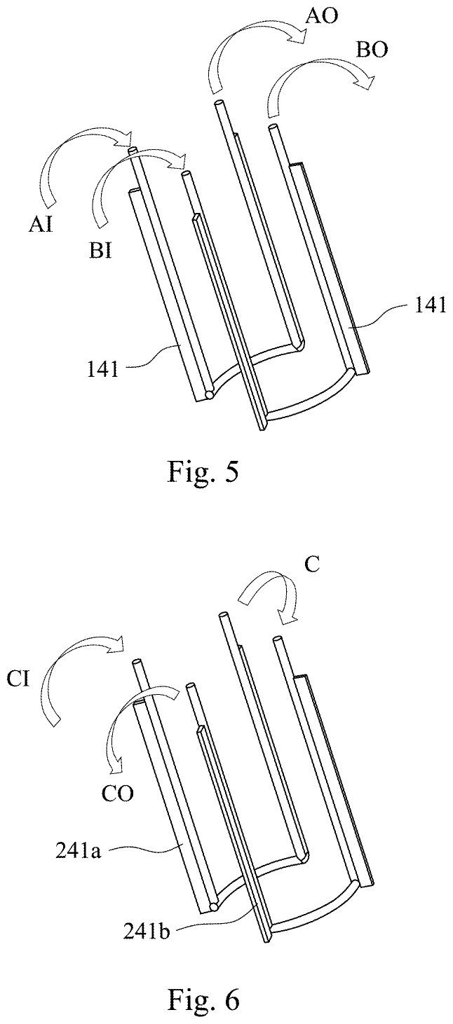

The cooling structure 140 includes at least one cooling tube 141 for allowing a cooling liquid passing through the chamber 110. In details, the microwave applicator 100 of the present disclosure has the cooling structure 140 disposed in the chamber 110 for avoiding the temperature inside the chamber 110 from overheat. The cooling structure 140 can be connected to an external cooling liquid, and the cooling liquid is introduced into the chamber 110 from one end of the cooling tube 141. The cooling liquid flows along the cooling tube 141 for passing through the chamber 110 and then leaves the chamber 110 from the other one end of the cooling tube 141 for cooling down the temperature inside the chamber 110. FIG. 5 is a schematic view of the cooling tubes 141 of FIG. 1. A number of the cooling tube 141 is two as shown in FIG. 1 and FIG. 5, and each of the cooling tubes 141 is independently disposed in the chamber 110. Thus, inflow directions of the cooling liquid of the cooling tubes 141 are indicated, respectively, by arrows AI, BI. Furthermore, outflow directions of the cooling liquid of the cooling tubes 141 are indicated, respectively, by arrows AO, BO. That is, the two cooling tubes 141 are not communicated with each other. Moreover, depending on the requirements, the cooling structure 140 can further include a coil for increasing the temperature inside the chamber 110, and will not limited thereto.

FIG. 6 is a schematic view of cooling tubes 241a, 241b according to another embodiment of the present disclosure. In FIG. 6, the two cooling tubes 241a, 241b are communicatively disposed in the chamber 110. The cooling liquid flows into the cooling tube 241a from one end thereof along a direction, which is indicated by an arrow CI. The cooling liquid leaves the cooling tube 241a from the other end of the cooling tube 241a along a direction, which is indicated by an arrow C, for entering the other cooling tube 241b. Then, the cooling liquid leaves the cooling tube 241b along a direction indicated by an arrow CO. Thus, only one cooling tube is connected to the resource of the cooling liquid so as to simplify the entire structure.

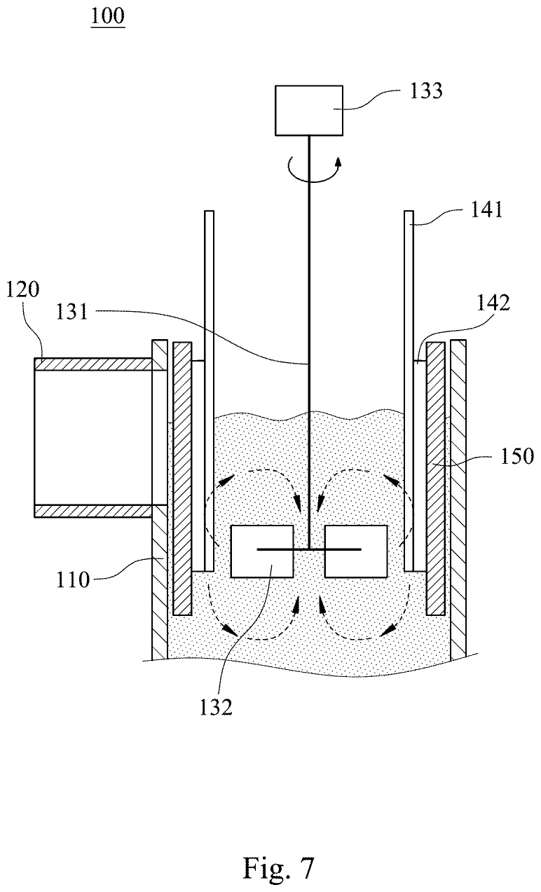

FIG. 7 is a partial cross-sectional view of the microwave applicator 100 of FIG. 1. In FIG. 1 and FIG. 7, the microwave applicator 100 can further include a blocking plate 150 disposed between the cooling tube 141 and the chamber 110. Because the microwave source 120 of the microwave applicator 100 of the present disclosure is introduced into the chamber 110 along only one direction, a specific zone, which is closer to the microwave source 120, has an obvious heating effect. Thus, the stirrer 130 is required to stir the object in the chamber 110 to allow the object to be evenly heated and improve the chemical reaction. However, a heat exchange rate at an interface between the inner wall of the chamber 110 and the surface of the object in the chamber 110 only can be slightly improved by promoting conduction, convection or utilizing the stirrer 130. Thus, the arrangement of the blocking plate 150 further prevents the object to be heated from flowing so as to stabilize the vortex and the kinetics of the stirring provided by the stirrer 130. Thus, the object can receive the heat evenly.

Furthermore, the cooling structure 140 can further include at least one connecting member 142 for connecting the blocking plate 150 with the cooling tube 141 as shown in FIG. 1 and FIG. 7. In particular, a number of the cooling tube 141 is two as shown in FIG. 1. Thus, a number of the connecting member 142 is four for fitting the shape and number of the cooling tubes 141. Every two of the connecting members 142 are connected the cooling tube 141 with the blocking plate 150, so that the cooling tubes 141 can be more firmly disposed in the chamber 110.

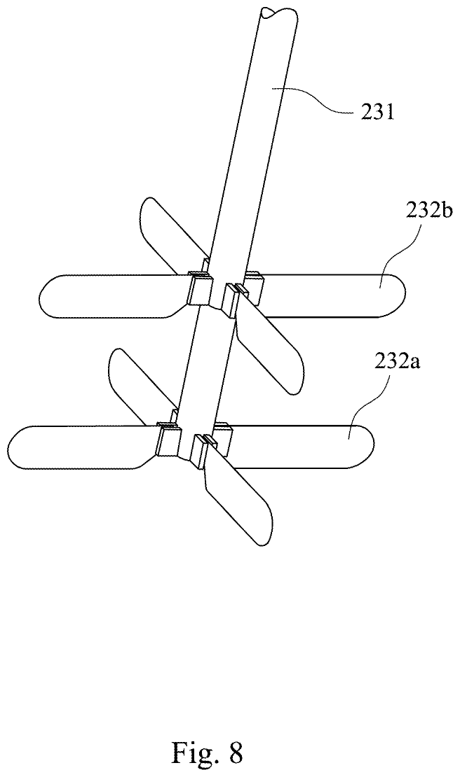

FIG. 8 is a schematic view of an axial member 231 and blades 232a, 232b of a microwave applicator according to another embodiment of the present disclosure. A number of the blades is eight as shown in FIG. 8, and four blades 232a and the other four blades 232b are connected to different positions of the axial member 231. That is, the four blades 232a are connected to a first position (its reference numeral is omitted) of the axial member 231, and the other four blades 232b are connected to a second position (its reference numeral is omitted) of the axial member 231. A distance between the first position and the bottom of the chamber 110 is different from a distance between the second position and the bottom of the chamber 110, and it is favorable for broadly stirring the object in the chamber 110 to improve the uniformity of the heating process and the reaction.

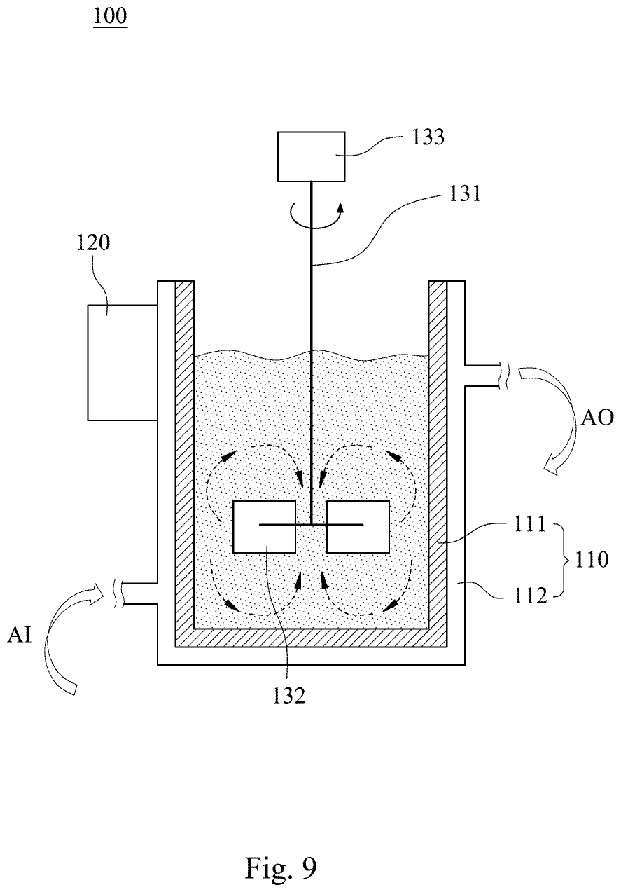

FIG. 9 is a schematic view of the microwave applicator 100 according to yet another embodiment of the present disclosure. The microwave applicator 100 includes the chamber 110, the at least one microwave source 120 and the stirrer 130.

In details, the chamber 110 includes an inner chamber wall 111 and an outer chamber wall 112. The outer chamber wall 112 surrounds the inner chamber wall 111 and includes a cooling chamber (its reference numeral is omitted). The cooling chamber is for introducing a cooling liquid thereinto. Moreover, the liquid introduced could be hot also, depending on the reaction condition needed. As shown in FIG. 9, the cooling liquid can flow into the cooling chamber of the outer chamber wall 112 through an opening of the outer chamber wall 112 in an inflow direction (indicated by ab arrow AI) and flow outward in an outflow direction (indicated by an arrow AO) through another opening of the outer chamber wall 112. However, the present disclosure is not limited thereto.

The microwave source 120 is disposed on the outer chamber wall 112 of the chamber 110 for evenly heating the object within the chamber 110 so as to raise the reaction rate of the chemical reaction of the object in the chamber 110. When the object is overheated by the microwave source 120 without boiling, it will boil immediately and splash out as the chamber 110 is shaken by an external force. To solve the above-mentioned issue, the cooling chamber of the outer chamber wall 112 and the cooling liquid conducted into the cooling chamber can be applied for stabilizing the heating process.

The stirrer 130 includes the axial member 131 and the blades 132. Each of the blades 132 is connected to the axial member 131, and the axial member 131 and the blades 132 are made of metal materials. The axial member 131 can be forced to rotate for driving the blades 132 to stir the object within the chamber 110. The arrangement of the metal components, that is, the blades 132 and the axial member 131, can enhance the strength of the stirrer 130 for stirring the sticky object. Furthermore, the blades 132 and the axial member 131, which are made of the metal materials, can achieve a converging electric field for allowing the microwaves focusing on the object so as to improve the efficiency of speeding up the chemical reaction rate by the microwaves.

In the microwave applicator of FIG. 9, the configuration, such as the number, shape or position of the blades 132, can be the same as the above-mentioned embodiment. Thus, there is no further description herein.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A microwave applicator, comprising:
a chamber;
at least one microwave source disposed on one side of the chamber;
a stirrer disposed in the chamber and comprising:
an axial member; and
a plurality of blades, each of the blades connected to the axial member, wherein the axial member and the blades are made of metal materials; and
a cooling structure disposed in the chamber and comprising:
at least one cooling tube for allowing a cooling liquid passing through the chamber.

2. The microwave applicator of claim 1, wherein a number of the blades is four.

3. The microwave applicator of claim 2, wherein an angle between each two of the blades which are adjacent to each other is 90 degrees.

4. The microwave applicator of claim 1, wherein angles between every two of the blades which are adjacent to each other are equal.

5. The microwave applicator of claim 1, wherein an edge of each of the blades is arc-shaped.

6. The microwave applicator of claim 1, wherein a number of the cooling tube is two, and each of the cooling tubes is independently disposed in the chamber.

7. The microwave applicator of claim 1, wherein a number of the cooling tube is two, and the two cooling tubes are communicatively disposed in the chamber.

8. The microwave applicator of claim 1, further comprising:
a blocking plate disposed between the cooling tube and an inner wall of the chamber.

9. The microwave applicator of claim 8, wherein the cooling structure further comprises at least one connecting member for connecting the blocking plate with the cooling tube.

10. The microwave applicator of claim 1, wherein a number of the blades is eight, four of the blades and the other four of the blades are connected to different positions of the axial member.

11. The microwave applicator of claim 1, wherein the stirrer further comprises:
a motor connected with the axial member.

12. A microwave applicator, comprising:
a chamber comprising:
an inner chamber wall; and
an outer chamber wall surrounding the inner chamber wall and comprising a cooling chamber for introducing a cooling liquid thereinto;
at least one microwave source disposed on the outer chamber wall of the chamber;
a stirrer disposed in the chamber and comprising:
an axial member; and
a plurality of blades, each of the blades connected to the axial member, wherein the axial member and the blades are made of metal materials.

13. The microwave applicator of claim 12, wherein a number of the blades is four.

14. The microwave applicator of claim 13, wherein an angle between each two of the blades which are adjacent to each other is 90 degrees.

15. The microwave applicator of claim 12, wherein angles between every two of the blades which are adjacent to each other are equal.

16. The microwave applicator of claim 12, wherein an edge of each of the blades is arc-shaped.

17. The microwave applicator of claim 12, wherein a number of the blades is eight, four of the blades and the other four of the blades are connected to different positions of the axial member.
